(19) United States
(12) Patent Application Publication
(10) Pub. No.: US 2005/0123340 A1
(43) Pub. Date: Jun. 9, 2005

(54) Method and apparatus for incorporation of author specific characteristics into handwriting

(76) Inventor: Patrick O'Neal Nunally, Escondido, CA (US)

Correspondence Address: Patrick Nunally, 2227 Villa Verde Road, Escondido, CA, 92029, US

(21) Appl. No.: 10/730,243

(22) Filed: Dec. 5, 2003

(51) Int. Cl. B43K 29/00

(52) U.S. Cl. 401/195

(57) ABSTRACT

An instrument, method and apparatus for application of a time varying characteristics to marks produced by a writing instrument such that variations in the speed of writing are directly inscribed in the writing. This invention allows personal identity to be recorded into everyday signatures and handwritten transactions.

### FIELD OF THE INVENTION

This invention relates to depositing characteristic parameters of an author's handwriting, such as stroke speed, based on a time varying marking instrument which varies its marking at a fixed time rate such that, as marks are made with the instrument, the author's stroke characteristics create an uneven distribution of constant rate variability, thereby making the handwriting significantly more difficult to forge.

### BACKGROUND OF THE INVENTION

Considerable work has already been carried out on the dynamic analysis of writing. Thus, the translation of the speed of writing into a proportional electrical signal has already been proposed. To achieve this object, it has been proposed, in particular, that the acceleration of the writing instrument be measured and the speed be deduced there from by integration of the measured acceleration. The presence of measuring elements on the writing instrument makes it necessary to connect the instrument to a data processing apparatus. This involves the presence of a wire or wireless link. Moreover, accelerometers are sensitive to their orientation about the longitudinal axis of the writing instrument. This is why a solution in which the instrument is insensitive to its physical orientation is desirable.

It has been proposed that this disadvantage be overcome by using a system of inductive pick-ups of the type described in PCT Application No. W079/00363. With this method of measurement, voltages are induced in two portions of crossed coils placed beneath the writing surface, by a permanent magnet placed in the pen.

Solutions utilizing systems of contacts have been proposed as, for example, in U.S. Pat. No. 4,078,226. These systems are awkward, as they have to be sensitive to slight pressures at any point on the writing substrate. It has also been proposed that the contact system be placed on the writing instrument, on the assumption that a source of current is coupled to the instrument or is connected thereto. Even in this case, the contact is a source of malfunctioning, not to mention the complication of the solution.

Moreover, U.S. Pat. No. 4,029,899 discloses a graphic detection device comprising a plurality of coils arranged alternatively in opposite directions to produce a signal when a magnetic flux passes from one coil to another, which is characteristic of the position of the writing instrument connected to the magnetic flux. Such a device is not therefore linked directly to the measurement of the dynamics of writing but, rather, is related to the graphical reproduction of the kinetics of the writing.

In U.S. Pat. No. 5,688,063 a writing instrument incorporating a massaging means has been proposed. This prior art makes use of a mechanical means similar to one aspect of this invention to achieve a substantially different goal of massaging areas of the body using said writing instrument.

In U.S. Pat. No. 6,424,728 an automatic signature verification system is set forth that utilizes algorithms to compare signature morphologies to known signature features. This prior art makes use of a verification means, which do not incorporate the added advantage of real-time signature dynamics, and in fact this type of signature verification has been limited in its applications and past over for dynamic signature analysis systems because of its inability to incorporate dynamic signature metrics onto the page.

Consequently, the prior art makes use of complex computational environments, dynamic physical tracking of writing instruments, and specialized signature tablets, each of which must be associated with a computational system for the capturing of said information. These prior art solutions substantially limit the application of handwriting biometrics because the information must be electronically captured and stored. A solution which allows for a significantly more general and intuitive use of biometrics is very desirable, particularly one which allows measurable user specific characteristics to be embedded into typical handwriting for paper applications without reliance on computational, database, and/or networked resources or the like.

### BRIEF SUMMARY OF THE INVENTION

The object of the present invention is to overcome the disadvantages of the aforementioned solutions particularly to enable the simplistic incorporation of measurable author-specific characteristics into handwritten words and signatures on a physical document.

The system and method of the present invention provides a reliable means of personal identification recording without complex and expensive systems by incorporation of measurable author specific characteristics such as the speed of handwriting, directly into a handwritten passage or signature. The invention includes variation of the mark made by a writing instrument at a fixed or patterned rate of change, which results in an uneven distribution of the fixed or patterned rate of change as a result of the unique biometrics of the author. These fixed or varied changes in marking can in some applications require rates of change above 30 cycles per second.

The apparatus of the invention allows a person to simply write on or otherwise sign ordinary paper and, in doing so, deposit an identifiable record embedded in the writing, which is unique to the person. The apparatus of the invention can incorporate fixed or patterned rates of change indicating changes in pressure, shape, direction, speed and velocity in a hand written ink writing or signature. This invention permits biometric identification to be performed based on the writing or signature immediately or at a much later date by untrained individuals, or by automated means such as a secure independent server. Central to the invention is that the biometric record is directly incorporated into the writing or signature on a physical document. No computational or digital storage means are necessary to record the signature, and as such a document written and/or signed using the method and apparatus of this invention bears biometric indicators of the signer indefinitely.

This invention overcomes all of the disadvantages of dynamic-signature biometric solutions by enabling the incorporation of a plurality of author-resultant variations to handwritten words and signatures. Additionally, the invention records these variations directly onto a physical document and requires no computational infrastructure to make use of the encoding aspects of the invention.

In a very natural and trusted way, this invention enhances the value of a hand-written word, passage, or signature by making it a secure personal identifier.

### BRIEF DESCRIPTION OF THE DRAWINGS

In order that the manner in which the foregoing and other objects are attained in accordance with the invention can be understood in detail, particularly advantageous embodiments thereof will be described with reference to the accompanying drawings, which form a part of this specification, and wherein:

FIGS. 1 illustrates a fixed frequency being used to mark at three differing speeds in accordance with one embodiment of the invention and illustrating one aspect thereof;

FIG. 2 illustrates a fixed frequency being used to mark at three differing speeds, where color of marking is varied in accordance with one aspect of the invention and illustrating aspects thereof;

FIG. 3 illustrates a fixed frequency being used to mark at three differing speeds, where continuity of marking is varied in accordance with one aspect of the invention and illustrating aspects thereof;

FIGS. 4 illustrates a fixed frequency being used to mark at three differing speeds, where width of marking is varied in accordance with one aspect of the invention and illustrating aspects thereof;

FIG. 5 illustrates a fixed frequency being used to mark at three differing speeds, where microdots deposition is varied in accordance with one aspect of the invention and illustrating aspects thereof;

FIG. 6 illustrates signer verification processes using a fixed frequency of variation in accordance with one aspect of the invention and illustrating aspects thereof.

FIG. 7 is a sectional view of the present invention, showing the means for incorporation of author specific characteristics into handwriting unit started; and,

FIG. 8 is a sectional elevation of the present invention, showing the point of the refill extended out of the bottom barrel.

### DETAILED DESCRIPTION OF A PREFERRED EMBODIMENT

The invention can be embodied in an article, a system and a method for signature substantiation, particularly in one or more writing instruments that produce signer-specific characteristics such as handwriting speed. A writing instrument which incorporates this technology can be characterized generally in that marks made by the instrument vary at a fixed or patterned rate of change, which when used in handwriting applications embeds a detectable trace that is unique to the user.

One distinct advantage of the technology is the integration of distinctive characteristics of a person into handwritten paper/pen signatures on such documents as contracts, bank checks, etc. This invention uses time variation of the marking of a writing instrument, which can take on many forms. For example, time variation can be a simple mechanical motion or vibration incorporated into the writing instrument such that the effects of the motion are uniquely distributed throughout individual handwriting.

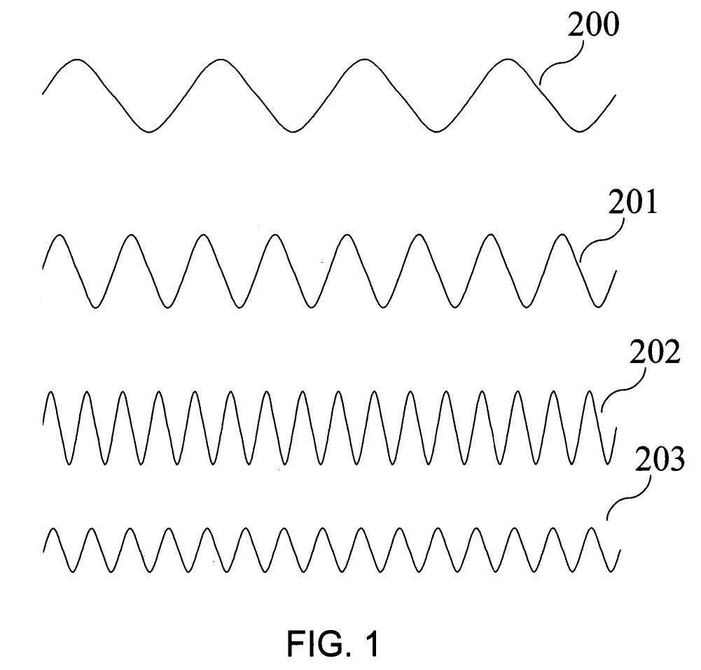

An example of time variation within marking is illustrated in FIG. 1, where a fixed frequency of vibration is used to mark at three differing speeds. As the writing instrument is moved (as measured in cm/sec) from left to right in the illustration the fixed oscillation frequency (which has been enlarged for purposes of illustration) of the writing instrument produces marks which incorporate both the speed of the writing instrument and pressure which was being applied at the time of marking. Mark 200, 201 and 202 has each been created with the same fixed frequency of vibration of the marking instrument however mark 200 was written at twice the physical speed of mark 201 which in turn written at twice the physical speed of mark 202. In FIG. 1 marks 200, 201 and 202 each illustrates fixed amplitude (which has been greatly enlarged for illustrative purposes) however mark 203 illustrates the effect of stroke pressure, which alters amplitude as well as frequency of mark hence in evaluating the resulting writing for substantiation of authorship either computationally or by other means amplitude and frequency in combination can be used to derive both stroke speed and pressure used to create the marks.

In practical applications where writing instruments are held at angles to the writing surface a vibration will effectively lift the pen point on an off the writing surface and as such it is desirable to select the fixed amplitude of the frequency in order that handwriting be legible and useful. Thus, in evaluating the resulting writing for substantiation of authorship either computationally or by other means amplitude and frequency in combination analyzed in relation to the total content of any given mark can be used to derive authentication of the author of the written material.

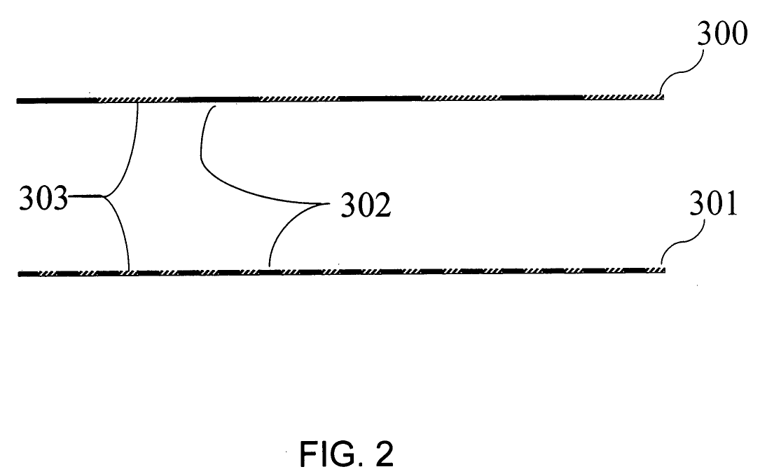

FIG. 2 shows an embodiment of and alternate implementation of this invention, where the mark's color or constitution is used to mark at two differing speeds. As the writing instrument is moved from left to right in the illustration the fixed color change frequency of the writing instrument produces marks which are dependent on the speed at which the writing instrument was moving at the time of marking. Mark 300 and 301 has each been created with the same fixed frequency of color or constitution of the marking instrument however mark 300 was written at twice the physical speed of mark 301 varied so that the writer perceives no tactile effect. The speed of marking can be derived from the relative length of continuous mark color 302 and 303 or composition.

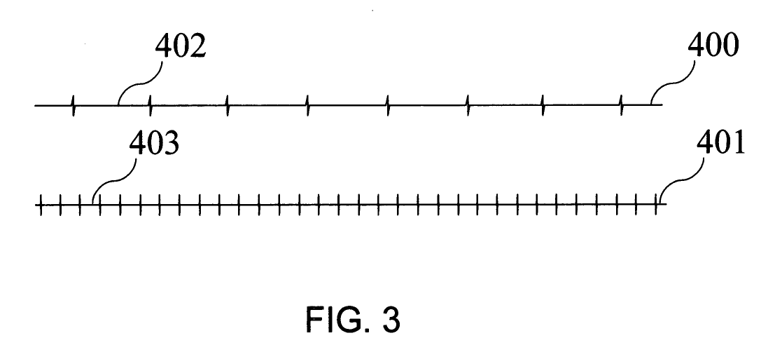

FIG. 3 shows yet another variation, which minimizes the total root mean square amplitude variation of the marking, by inserting discontinuity into the marking, where the mark's continuity is used to mark at three differing speeds. As the writing instrument is moved from left to right in the illustration the fixed continuity frequency of the writing instrument produces marks which are dependent on the speed at which the writing instrument was moving at the time of marking. Mark 400 and 401 has each been created with the same fixed frequency of continuity of the marking instrument however mark 400 was written at twice the physical speed of mark 401 varied so that the writer perceives no tactile effect. The speed of marking can be derived from the relative length of marking between mark discontinuities 402 and 403.

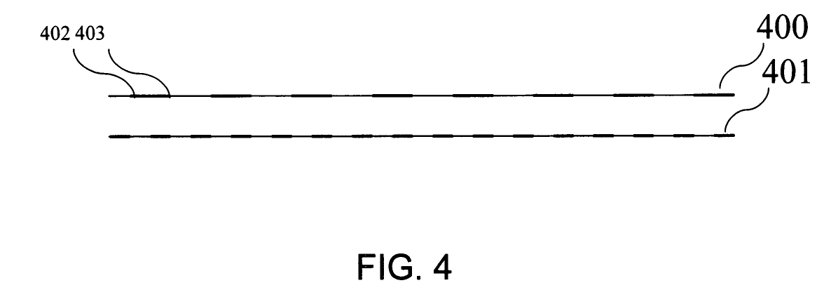

Still another discontinuous marking variation, which minimizes the total root mean square amplitude variation of the marking, is the varied- width marking illustrated in FIG. 4. FIG. 4 illustrates inserting discontinuity of width into the marking, where the mark's width continuity is used to mark at two differing speeds. As the writing instrument is moved from left to right in the illustration the fixed width continuity frequency of the writing instrument produces marks which are dependent on the speed at which the writing instrument was moving at the time of marking. Mark 500 and 501 has each been created with the same fixed frequency of width continuity of the marking instrument however mark 500 was written at twice the physical speed of mark 501 varied so that the writer perceives no tactile effect. The speed of marking can be derived from the relative length of marking between mark discontinuities 502 and 503.

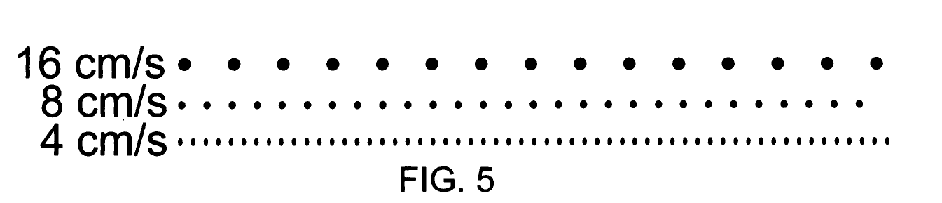

Yet another embodiment of the invention is the deposition fixed or patterned time depositions of microdots, which is illustrated in FIG. 5. The implementation shown in FIG. 5 eliminates amplitude variation, eliminates the need for multiple colors and provides a well-proven means of copy protection while delivering an actual indication of the signer. A writing instrument incorporating this technology provides a reliable means to record and subsequently verify that an author of a given handwritten signature is indeed a specific person.

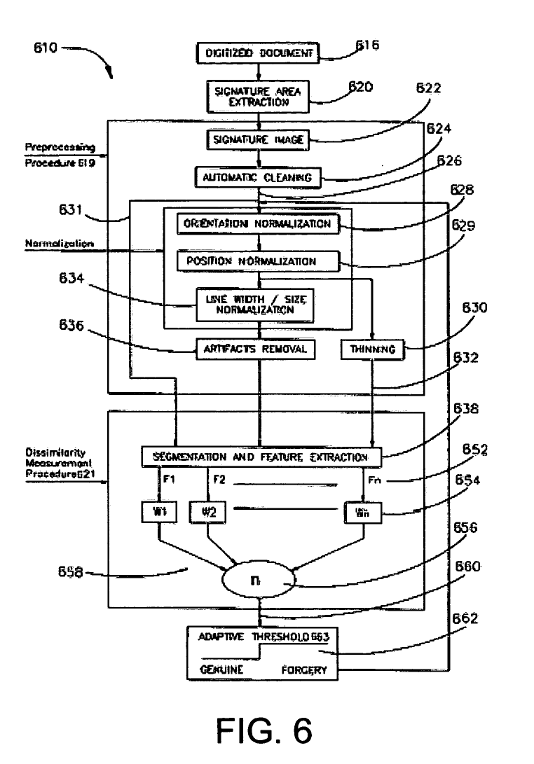

Corroboration of the resultant signature generated via the processes and/or apparatus outlined herein can be performed via course visual means, simplified image processing ratio matching algorithms or much more advanced Dynamic Signature Analysis software algorithms. Referring now to FIG. 6, automatic signature verification, or comparison, program 610 will be discussed following a flow chart methodology. Target signature, or input data 616, in the form of digitized data usually generated by a scanner or the like, representing information of an image of a encoded signature from a bank card, check, or the like, is supplied to program 610. From image data 616, an encoded signature area 620 is extracted according to the coordinates of the signature area specified in the particular document type. If original image data 616 is in gray level form, the image from signature area 620 is manipulated to obtain a binary image 622. Binary image 622 is then automatically cleaned 624 using connected component labeling based cleaning with horizontal and vertical line elimination taking place. After automatic cleaning 24 the resulting data represents a clean binary signature image 626 with any background characters, lines and noise eliminated. Cleaned binary signature image 626 is then prepared for encoded feature extraction using forensic handwriting analysis techniques. Image 626 is then checked for orientation. If required, image 626 is normalized to a horizontal position in an orientation normalization routine 628. The orientation normalization routine 628 is only used if target signature 616 is found to be a forgery, since this finding could result from a change in the general orientation of a genuine signature from a normal position. Next, a position normalization routine 629 is utilized to position binary signature image 622. Position normalization routine 629 utilizes a methodology wherein binary image 622 is set to an origin of coordinates at a center of gravity of image 622 such that the later comparison is independent of the relative position of cleaned binary image 626 within signature area 620.

At this point in processing, cleaned binary image 626 continues on parallel paths. Mean amplitude modulation derived from a line thinning routine 630 results in a mapping of relative signature amplitude modulation within the strokes represented in the image 632. Mean amplitude modulation signature image 632 represents an image where the signature lines are reduced to approximately one pixel in width. Along a parallel path, cleaned binary image 626, which may also be position normalized, is then normalized with respect to writing line width and writing line size in writing width and size normalization routine 634. At this point in the processing of the signature image some debris or artifacts may appear due to the prior processing routines. This debris or artifacts are now removed in a filtering routine 636 in preparation for sending the signature image to the next step in its processing.

Three images are now ready to be processed by a segmentation and feature extraction routine 638. Cleaned binary image 626, size and line width normalized image 40 (resulting from writing width and size normalization routine 634) and mean amplitude modulation signature image 632 are sent to dissimilarity measure block 642.

Two additional features comprising complex elements are extracted by matching and mismatching a linear profile of processes target signature 616 with a sliding linear profile of at least one training sample. Next, slant features 652 are measured for dissimilarity in dissimilarity measure routine 642. A comparative distance measure is made using a weighted Euclidean methodology 656. A feature set 658 is automatically selected using automatic evaluating program 614 for dissimilarity measurements. The weighting of the Euclidean distance measurement equations are also automatically selected by automatic evaluating program 614, as described in further detail below.

Dissimilarity measurements 660 give the distance relationship of selected features of target signature 616. This measure gives an indication of how far target signature 616 is from a set of training, or authentic, samples of the same person's signature. If all the training samples and target signatures are copies of each other, the dissimilarity measure is zero. To the degree that the training samples differ from each other and the target signature differs from them, the dissimilarity measure rises proportionally to that degree. For a specific person's signature, there is a natural degree of variation in the values of the features of the samples of their signature such that there is a natural range of dissimilarity measurement of the person. If the dissimilarity measure of the target signature exceeds this natural range, the target signature is judged to be an attempted forgery, otherwise, it is accepted as genuine. Computing this natural range is done with the help of automatic evaluating program 614, as described below.

Next, an adaptive decision threshold routine 662 determines an upper limit of the natural range of the dissimilarity measure of a specific person. The upper limit of the adaptive threshold is computed using parameters obtained from automatic evaluation program 614.

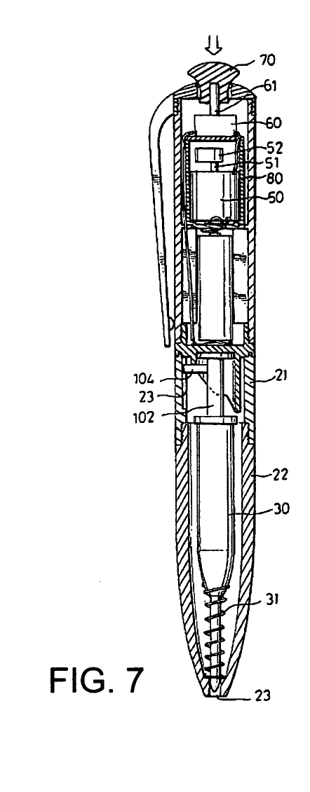

Referring to FIG. 7, a writing apparatus with biometric inclusion means in accordance with the present invention includes a writing unit, and a biometric unit. The writing unit is comprised of an upper barrel 10, a bottom barrel 20, and a refill 30. The biometric unit is comprised of a battery 40, a motor 50, a single pole single throw (SPST) switch 60, and activating button 70.

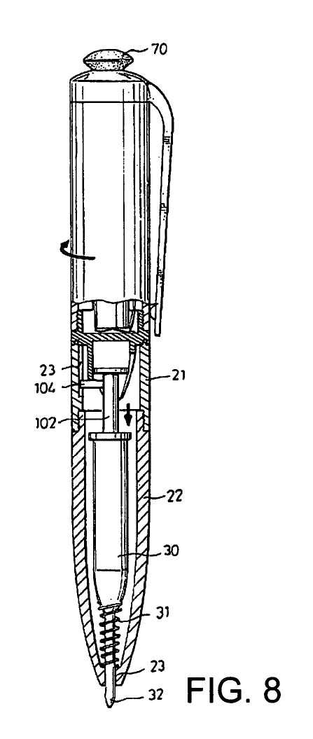

Referring to FIG. 8 and FIG. 7 again, the motor 50 is mounted within a shell 80 inside the upper barrel 10, having an output shaft 51, and an eccentric wheel 52 fastened to the output shaft 51. The shell 80 is mounted within the upper barrel 10, supported on an inside annular flange 11 of the upper barrel 10, and covered with a top cover 81. The SPST switch 60 is mounted on the top cover 81 of the shell 80. The battery 40 is mounted within the upper barrel 10 below the shell 80, and electrically connected to the motor 50 through the SPST switch 60 by conductors. The activating button 70 has a bottom rod 72 defining a bottom coupling hole 71. The bottom-coupling hole 71 of the activating button 70 is coupled to the press button 61 of the SPST switch 60. A pen cap 90 is fastened to the top opening 12 of the upper barrel 10 by a screw joint, having a through hole 91 through which the bottom rod 72 of the activating button 70 passes, and a clip 92 for fastening. The bottom barrel 20 is comprised of a first barrel section 21 and a second barrel section 22 fastened together by a screw joint. The detachable two-section design of the bottom barrel 20 facilitates the installation of the refill 30. The refill 30 is supported on a spring 31, and connected to an actuating mechanism 100. The actuating mechanism 100 comprises a rotary tube 101, and a propelling rod 102. The rotary tube 101 is fastened to the bottom end of the upper barrel 10 by a screw joint, having a bevel guide 103. The propelling rod 102 has a transverse rod 104 perpendicularly raised from the periphery, disposed in contact with the bevel guide 103, and forced by the bevel guide 103 to move along a track 23 in the first barrel section 21 of the bottom barrel 20. When the rotary tube 101 is turned, the transverse rod 104 of the propelling rod 102 is forced to move along the track 23, and therefore the refill 30 is moved vertically.

Referring to FIG. 8 again, when the activating button 70 is pressed, the SPST switch 60 is switched on, thereby causing the motor 50 to turn the eccentric wheel 52. When the eccentric wheel 52 is rotated, vibrating waves are directly transmitted through the shell 80 to the refill 30, and fully acted on the resultant marks made by refill 30.

Referring to FIG. 9, when the upper barrel 10 is turned in one direction relative to the bottom barrel 20, the rotary tube 101 is simultaneously turned with the upper barrel 10, causing the transverse rod 104 of the propelling rod 102 to be moved downwards along the track 23 and the spring 31 to be compressed, and therefore the point 32 of the refill 30 is forced out of the bottom end 23 of the second barrel section 22 of the bottom barrel 20 for writing. On the contrary, when the upper barrel 10 is turned in the reversed direction, the spring 31 is released, and the point 32 of the refill 30 is received in the second barrel section 22 of the bottom barrel 20 again.

While only one embodiment of the present invention has been shown and described, it will be understood that various modifications and changes could be made thereunto without departing from the spirit and scope of the invention disclosed.

Though use of the systems, methods and apparatus of this invention forged signatures are easily distinguishable from true ones based on the consistency created by the natural, highly practiced, motion and rhythm established by an original signer. This system and method creates a unique and recognizable data pattern in the original signature, which is essentially as unique as a fingerprint.

The invention applies a constant time variation to marks produced by a writing instrument so that variations in the speed of writing, which cannot be mimicked, are directly inscribed on the page. This invention allows personal identity to be recorded into everyday signature transactions, which are anticipated to be important in market segments such as Security, Document Management, Health Care, Banking and Commerce, Legal, Process Control, Personal Identity Protection, Government and others.

The invention is adapted to enable low cost writing instruments to deliver enhanced protection for the use of signatures to authorize transaction authorizations and record personal identification.

While certain advantageous embodiments have been chosen to illustrate the invention it will be understood by those skilled in the art that various changes and modifications can be made therein without departing from the scope of the invention as defined in the appended claims.

1. A method of incorporating biometric indicators into handwriting by varying the mark produced by a writing instrument at a predetermined rate.

2. The method according to claim 1, wherein said predetermined rate of variation is a fixed value.

3. The method according to claim 2, wherein said varying of said mark is achieved though vibration of said writing instrument.

4. The method according to claim 2, wherein said varying of said mark is achieved though altering the color of said mark.

5. The method according to claim 2, wherein said varying of said mark is achieved though altering the width of said mark.

6. The method according to claim 2, wherein said varying of said mark is achieved though altering the composition of said mark.

7. The method according to claim 2, wherein said varying of said mark is achieved though altering the continuity of said mark.

8. The method according to claim 1, wherein said predetermined rate of variation is a series of values.

9. The method according to claim 8, wherein said varying of said mark is achieved though vibration of said writing instrument.

10. The method according to claim 8, wherein said varying of said mark is achieved though altering the color of said mark.

11. The method according to claim 8, wherein said varying of said mark is achieved though altering the width of said mark.

12. The method according to claim 8, wherein said varying of said mark is achieved though altering the composition of said mark.

13. The method according to claim 8, wherein said varying of said mark is achieved though altering the continuity of said mark.

14. A writing instrument which incorporates biometric indicators into handwriting by producing marks with a characteristic that varies at a predetermined rate.

15. A writing instrument according to claim 14, wherein said predetermined rate of variation is a fixed value.

16. A writing instrument according to claim 15, wherein said varying of said mark is achieved though vibration of said writing instrument.

17. A writing instrument according to claim 15, wherein said varying of said mark is achieved though altering the color of said mark.

18. A writing instrument according to claim 15, wherein said varying of said mark is achieved though altering the width of said mark.

19. A writing instrument according to claim 15, wherein said varying of said mark is achieved though altering the composition of said mark.

20. A writing instrument according to claim 15, wherein said varying of said mark is achieved though altering the continuity of said mark.

21. A writing instrument according to claim 14, wherein said predetermined rate of variation is a series of values.

22. A writing instrument according to claim 21, wherein said varying of said mark is achieved though vibration of said writing instrument.

23. A writing instrument according to claim 21, wherein said varying of said mark is achieved though altering the color of said mark.

24. A writing instrument according to claim 21, wherein said varying of said mark is achieved though altering the width of said mark.

25. A writing instrument according to claim 21, wherein said varying of said mark is achieved though altering the composition of said mark.

26. A writing instrument according to claim 21, wherein said varying of said mark is achieved though altering the continuity of said mark.
